(19) United States
(12) Patent Application Publication
(10) Pub. No.: US 2026/0122413 A1
(43) Pub. Date: Apr. 30, 2026

(54) WATERPROOF ASSEMBLY FOR SOUND TRANSMISSION HOLE OF ACOUSTIC DEVICE

(71) Applicant: SHENZHEN SHOKZ CO., LTD., Shenzhen (CN)

(72) Inventors: Wenbing ZHOU, Shenzhen (CN); Yujia HUANG, Shenzhen (CN); Hao KE, Shenzhen (CN); Henghao ZHANG, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/433,935

(22) Filed: Dec. 28, 2025

Related U.S. Application Data
(63) Continuation of application No. PCT/CN2023/143660, filed on Dec. 29, 2023.

(51) Int. Cl. H04R 1/44; H04R 1/02; H04R 1/10

(52) U.S. Cl. CPC H04R 1/44; H04R 1/02; H04R 1/1008

(57) ABSTRACT

Provided is a waterproof assembly for a sound transmission hole of an acoustic device. The waterproof assembly includes a waterproof membrane, a buffer member, and a support member. The waterproof membrane is configured to allow air molecules to pass through and block water molecules from passing through. The buffer member includes an adhesive surface. The adhesive surface is adhesive so as to adhere the waterproof assembly to a target surface after being subjected to an external pressure. The support member is located between the waterproof membrane and the buffer member, and configured to reduce a degree of wrinkling of the waterproof membrane when the waterproof assembly is assembled. By providing the support member and the buffer member, the waterproof membrane is less prone to wrinkling and deformation during assembly into the acoustic device, thereby maintaining excellent acoustic performance and waterproof effect.

### CROSS-REFERENCE TO RELATED APPLICATIONS

This application is a Continuation of International Application No. PCT/CN2023/143660, filed on Dec. 29, 2023, the contents of which are incorporated herein by reference.

### TECHNICAL FIELD

The present disclosure relates to the field of electronic devices, and in particular, to a waterproof assembly for a sound transmission hole of an acoustic device.

### BACKGROUND

A housing of an acoustic device is typically provided with a sound transmission hole for sound to transmit from an external environment to the interior of the acoustic device or from the interior of the acoustic device to the external environment. When the acoustic device is used in an outdoor or a humid environment, liquids, such as water, can easily enter the acoustic device through the sound transmission hole on the housing. For example, the microphone of a wireless earphone must have a sound transmission hole for air-conducted sound transmission to pick up ambient sound and ensure call quality. When the user takes the wireless earphone underwater (e.g., swimming), water enters the interior of the earphone through the sound transmission hole. Water entering the wireless earphone may not only affect the normal function of its internal components, such as causing the microphone or speaker failure, but may also cause a short circuit in the mainboard or some components, resulting in that the user cannot use it normally.

Therefore, existing acoustic devices need to take certain measures to improve their waterproof performance, and in particular, enhance the waterproof protection of components such as the microphone and the speaker.

### SUMMARY

The present disclosure provides a waterproof assembly for a sound transmission hole of an acoustic device, which is capable of enhancing the waterproof performance of the acoustic device. The waterproof assembly includes a waterproof membrane, a buffer member, and a support member. The waterproof membrane is configured to allow air molecules to pass through and block water molecules from passing through. The buffer member includes an adhesive surface. The adhesive surface is adhesive so as to adhere the waterproof assembly to a target surface after being subjected to an external pressure. The support member is located between the waterproof membrane and the buffer member, and configured to reduce a degree of wrinkling of the waterproof membrane when the waterproof assembly is assembled to the acoustic device. The support member and the buffer member are respectively provided with a first through hole and a second through hole.

In some embodiments, the acoustic device includes an acoustic sensor, and the acoustic sensor is a speaker or a microphone. When the acoustic device is operating, at least part of sound waves are transmitted into or from the acoustic device through the waterproof membrane.

In some embodiments, the waterproof membrane includes a first waterproof surface and a second waterproof surface. The support member includes a first support member and a second support member. The first support member is connected to the first waterproof surface, and the second support member is connected to the second waterproof surface. The buffer member includes a first buffer member and a second buffer member. The first buffer member includes a first connection surface and a first adhesive surface, and the first connection surface is connected to the first support member. The second buffer member includes a second connection surface and a second adhesive surface, and the second connection surface is connected to the second support member.

In some embodiments, the waterproof membrane includes a first waterproof surface and a second waterproof surface. The buffer member includes a first connection surface and a first adhesive surface. One side of the support member is connected to the first waterproof surface, and another side of the support member is connected to the first connection surface.

In some embodiments, the support member and the waterproof membrane are connected by an adhesive layer, and a thickness of the adhesive layer is in a range of 0.03 mm to 0.15 mm.

In some embodiments, the waterproof membrane further includes a gauze mesh connected to the buffer member, so as to enhance a waterproof capability of the waterproof assembly.

In some embodiments, the acoustic device includes a housing, the sound transmission hole is provided on the housing, and the gauze mesh is provided on a side of the waterproof assembly close to the sound transmission hole.

In some embodiments, the buffer member and the support member are annular. The first through hole and the second through hole are circular holes. Diameters of the first through hole and the second through hole are in a range of 0.8 mm to 1.8 mm. Outer diameters of the buffer member and the support member are in a range of 2.4 mm to 4.6 mm.

In some embodiments, a thickness of the waterproof membrane is less than or equal to 0.10 mm.

In some embodiments, the buffer member is an elastic member, and when the waterproof assembly is assembled, the buffer member is a component with a largest elastic deformation in the waterproof assembly.

In some embodiments, a material of the buffer member includes foam adhesive or acrylic adhesive.

In some embodiments, a thickness of the buffer member is greater than or equal to 0.1 mm.

In some embodiments, a thickness of the support member is less than or equal to 0.1 mm.

In some embodiments, a total thickness of the waterproof assembly is in a range of 0.37 mm to 0.61 mm, so as to be installed in the acoustic device.

As can be seen from the above technical solution, the waterproof assembly provided in the present disclosure achieves the following advantages: by arranging the support member and the buffer member, the waterproof membrane is less prone to wrinkling and deformation during assembly into the acoustic device. As a result, the waterproof membrane can maintain excellent acoustic performance and waterproof effect. Furthermore, the support members and the buffer members in the present disclosure are symmetrically stacked on both sides of the waterproof membrane, so that the top and bottom of the waterproof membrane are supported and protected, and thus the waterproof membrane can maintain excellent acoustic performance and waterproof effect, thus enhancing the waterproof effect of the waterproof assembly.

Other features of the waterproof assembly provided in the present disclosure are listed below. Creative aspects of the waterproof assembly provided in the present disclosure may be adequately explained by practicing or using the manners, apparatuses, and combinations described in the detailed examples below.

### BRIEF DESCRIPTION OF THE DRAWINGS

In order to more clearly illustrate the technical solutions in the embodiments of the present disclosure, the drawings required to be used in the description of the embodiments will be briefly described below, and it will be apparent that the drawings in the following description are only some of the embodiments of the present disclosure, and that, to a person of ordinary skill in the art, they can obtain other drawings based on these drawings without creative labor.

FIG. 1A illustrates a structural diagram of an acoustic device according to some embodiments of the present disclosure;

FIG. 1B illustrates a structural diagram of a waterproof assembly according to some embodiments of the present disclosure;

FIG. 2A illustrates a schematic diagram of a waterproof membrane subjected to a pressure according to some embodiments of the present disclosure;

FIG. 2B illustrates a schematic diagram of a waterproof assembly subjected to a pressure according to some embodiments of the present disclosure;

FIG. 3 illustrates a schematic diagram of a structure of a waterproof assembly installed in an acoustic device according to some embodiments of the present disclosure; and

FIG. 4 illustrates a schematic diagram of a location of a gauze mesh according to some embodiments of the present disclosure.

### DETAILED DESCRIPTION

The following description provides application-specific scenarios and requirements of the present disclosure, and is intended to enable a person skilled in the art to make and use the contents of the present disclosure. Various local modifications to the disclosed embodiments will be apparent to those skilled in the art and, without departing from the spirit and scope of the present disclosure, the general principles defined herein may be applied to other embodiments and applications. Accordingly, the present disclosure is not limited to the embodiments shown, but rather to the broadest extent consistent with the claims.

The terminology used herein is for the sole purpose of describing particular example embodiments and is not limiting. For example, as used herein, the singular forms “one”, “a”, and “the” may also include plural forms, unless the context clearly indicates otherwise. When used in the present disclosure, the terms “comprises,” “contains,” and/or “includes” means that the associated integers, steps, operations, elements, and/or components are present, but does not preclude the presence of one or more other features, integers, steps, operations, elements, components, and/or groups or that other features, integers, steps, operations, elements, components, and/or groups may be added to the system/method.

In the present disclosure, the terms “up”, “down”, “left”, “right”, “front”, “back”, “top”, “bottom”, “inside”, “outside”, “vertical”, “horizontal”, “crosswise”, “longitudinal”, etc., indicate an orientation or positional relationship based on the orientation or positional relationship shown in the drawings. These terms are primarily intended to better describe the present disclosure and its embodiments, and are not intended to qualify that the indicated devices, elements, or components must have a particular orientation, or be constructed and operated in a particular orientation.

And, some of the above terms may be used to denote other meanings in addition to an orientation or positional relationship; for example, the term “up” may also be used to denote a dependency or connection in some instances. To a person of ordinary skill in the art, the specific meanings of these terms in the present disclosure may be understood on a case-by-case basis.

Additionally, the terms “mounting,” “setting,” “having,” “connecting,” and “connected” are to be understood broadly. For example, it may be a fixed connection, a removable connection, or an integral construction; it may be a mechanical connection, or an electrical connection; it may be a direct connection, or an indirect connection through an intermediate medium, or an internal connection between two devices, elements, or components. To a person of ordinary skill in the art, the specific meanings of the above terms in the present disclosure may be understood on a case-by-case basis.

In the present disclosure, “X includes at least one of A, B, or C” means that X includes at least A, or X includes at least B, or X includes at least C. That is to say, X may include only any one of A, B, or C, or any combination of A, B, and C at the same time, and other possible contents/elements. Any combination of A, B, and C may be A, B, C, AB, AC, BC, or ABC.

The “or” and “and/or” in the present disclosure describe an associative relationship between related objects, representing a non-exclusive inclusion. For example, each of “A and/or B” and “A or B” may include: only “A” exists, only “B” exists, and both “A” and “B” exist, where “A” and “B” may be singular or plural. As another example, each of “A, B, and/or C” and “A, B, or C” could include: only “A” exists, only “B” exists, only “C” exists, both “A” and “B” exist, both “A” and “C” exist, both “B” and “C” exist, and both “A”, “B”, and “C”exist, where “A”, “B”, and “C” may be singular or plural.

In the present disclosure, “plurality”means two or more.

In the present disclosure, unless explicitly stated otherwise, the associative relationship that arises between the structures may be either a direct associative relationship or an indirect associative relationship. For example, when describing “A is connected to B”, unless it is explicitly stated that A is directly connected to B, it should be understood that A may be directly connected to B, or indirectly connected to B; for example, when describing “A is above B”, unless it is explicitly stated that A is directly above B (AB is adjacent and A is above B), it should be understood that A may be directly above B, or indirectly above B (AB is separated by other elements and A is above B), and so on.

Taking into account the following description, these and other features of the present disclosure, the operation and functioning of the associated elements of the structure, and the economics of combining and fabricating the components, may be significantly improved. Referring to the figures, all of which form a part of the present disclosure. It should be clearly understood, however, that the figures are used for illustrative and descriptive purposes only and are not intended to limit the scope of the present disclosure. It should also be understood that the figures are not to scale.

The present disclosure is described in detail below by way of specific embodiments.

A housing of an acoustic device is typically provided with a sound transmission hole for sound to pass from an external environment to the interior of the acoustic device or from the interior of the acoustic device to the external environment. For example, a wireless earphone with a call function will have a sound transmission hole for a microphone to pick up sound, to receive sound traveling through the air, for the purpose of ensuring the quality of the call. To ensure that the acoustic device prevents liquid ingress to remain functional when used in outdoor or humid environments, it is necessary to do a liquid-proof treatment for the sound transmission hole of the acoustic device, for example, a waterproof structure is set up at the sound transmission hole to prevent liquid from entering. The present disclosure provides a waterproof assembly near the sound transmission hole of the acoustic device, and by providing liquid-proof treatment to the sound transmission hole, the liquid-proof capability of the acoustic device is enhanced. Liquids in the present disclosure include, but are not limited to, water, oil, sweat, or the like, and for ease of description, water is used as an example below. In the following descriptions, the waterproof assembly is described using a (wireless) earphone as an example of the acoustic device. The (wireless) earphone may be a bone conducting earphone, an air conducting earphone, or a bone-air conducting earphone. However, it is understood by those skilled in the art that the acoustic device may also be a cell phone, a computer, a tape recorder, or the like.

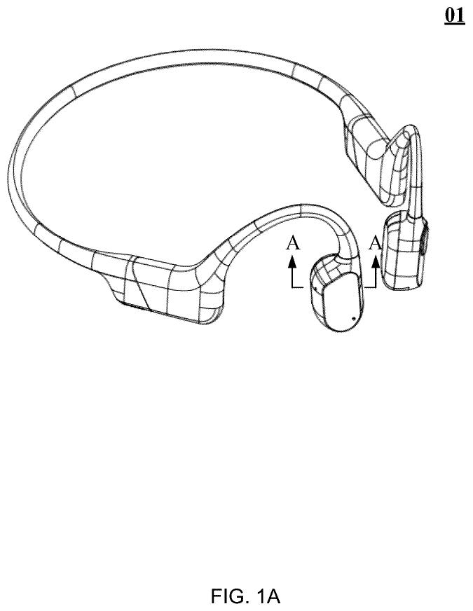

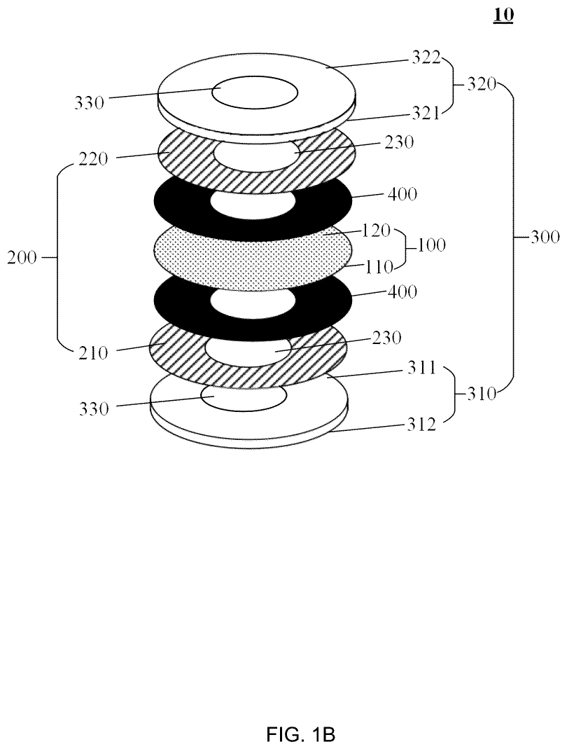

FIG. 1A illustrates a structural diagram of an acoustic device 01 according to some embodiments of the present disclosure. FIG. 1B illustrates a structural diagram of a waterproof assembly 10 according to some embodiments of the present disclosure.

The acoustic device 01 shown in FIG. 1A is a (wireless) earphone, and in the following description, a (wireless) earphone is used as an example of the acoustic device 01 for illustration. The (wireless) earphone may be a bone conducting earphone, an air conducting earphone, or a bone-air conducting earphone. It is understood that the acoustic device 01 may also be a cell phone, a computer, a tape recorder, or the like.

As shown in FIG. 1B, the waterproof assembly 10 may include a waterproof membrane 100, a support member 200, and a buffer member 300. The support member 200 may be located between the waterproof membrane 100 and the buffer member 300. In some embodiments, the waterproof assembly 10 may also include a gauze mesh (not shown in FIG. 1B).

The waterproof membrane 100 may allow air molecules to pass through and block water molecules from passing through. In some embodiments, the waterproof membrane 100 may be made of a waterproof and breathable material having an equivalent microporous structure. The waterproof and breathable material is characterized in such a way that the air molecules are allowed to pass through the equivalent microporous structure, and the water molecules are unable to pass through the equivalent microporous structure. Furthermore, the surface tension of the waterproof membrane 100 may cause the water droplets to form a sphere on the surface of the membrane, reducing the contact area between the water molecules and the waterproof membrane 100, thereby further enhancing the waterproof effect of the waterproof membrane 100. Specifically, an acoustic sensor such as a speaker or a microphone may be provided at the sound transmission hole of the acoustic device 01. When the acoustic device 01 is operating, the acoustic sensor transmits or receives sound waves. When the sound waves propagate to the interface of the waterproof membrane 100, the air molecules, due to the larger spacing between molecules and their smaller size, may freely enter and exit the equivalent microporous structure in the waterproof membrane 100. For example, environmental sound waves pass through the waterproof membrane 100 to be captured by the microphone. As another example, sound waves generated by the speaker pass through the waterproof membrane 100 to the outside of the acoustic device 01. That is, the pore size of the equivalent microporous structure of the waterproof membrane 100 needs to be such that the air molecules may pass through the equivalent microporous structure of the waterproof membrane 100 into the acoustic device or out of the acoustic device.

The material of the waterproof membrane 100 also needs to meet the requirements of the acoustic device 01 for water pressure resistance, the magnitude of its impact on the acoustic performance, etc. The waterproof membrane 100 needs to be able to withstand a water pressure of a preset value or more, and the preset value may be obtained by the acoustic device 01 during a waterproof test. For example, the earphone assembled with the waterproof membrane 100 is tested for dynamic waterproof and static waterproof, and the waterproof membrane 100 that achieves waterproof at IPX5 level and IPX68 level is selected, and the corresponding water pressure resistance value is selected as the preset value. The static waterproof test involves immersing the acoustic device installed with the waterproof membrane 100 into still water and subjecting it to a preset hydrostatic pressure to evaluate the waterproof performance of the waterproof membrane 100. The dynamic waterproof test involves immersing the acoustic device installed with the waterproof membrane 100 into water and simulating dynamic movements, such as swimming, to evaluate the waterproof performance of the waterproof membrane 100.

Additionally, the waterproof membrane 100 is required to have a low impact on acoustic performance. The impact of the waterproof membrane 100 on acoustic performance may be measured in terms of sound transmission loss. The sound transmission loss refers to a change in frequency distribution and volume of sound at a preset frequency after it passes through the waterproof membrane 100. If the waterproof membrane 100 acts as a medium for vibration to propagate the vibration of the sound, the frequency response characteristics of the waterproof membrane 100 itself on the vibration will act as a transfer function to affect the propagation of the sound, such as the decibel of sound passing through the waterproof membrane 100 decreases, and the frequency distribution changes. The selection of the waterproof membrane 100 should be such that the sound transmission loss is minimized. For example, the earphone may use the waterproof membrane 100 with a sound transmission loss of less than 2 dB.

In some embodiments, the material of the waterproof membrane 100 may be expanded Poly Tetra Fluoro Ethylene (ePTFE) or polyurethane (PU). Both of these materials fulfill the above requirements in terms of water pressure resistance and impact on acoustic performance. The ePTFE also has good corrosion and high-temperature resistance to enable the acoustic device 01 to be used in more scenarios. Of course, the ePTFE or the PU is only one of the many kinds of materials that may be used as the waterproof membrane in the present disclosure, and the waterproof membrane 100 in the present disclosure may also use other kinds of materials, and the present disclosure does not limit it.

In some embodiments, a thickness of the waterproof membrane 100 is less than or equal to 0.10 mm to ensure its waterproof capability while reducing the occupancy of the internal space of the housing. The shape of the waterproof membrane 100 may be designed or cut according to the installation requirements. As shown in FIG. 1B, the shape of the waterproof membrane 100 is circular. Of course, the shape of the waterproof membrane 100 may be square, oval, rectangular, runway, and other shapes, which are not required by the present disclosure herein.

The waterproof membrane 100 may be connected to the support member 200. The support member 200 may reduce a degree of wrinkling of the waterproof membrane 100 during installation of the waterproof assembly 10. When the waterproof assembly 10 is assembled into the earphone, the waterproof assembly 10 is typically subjected to an external pressure to ensure assembly stability. The external pressure may be the force of gravity of the acoustic assembly or pressure applied by a pressure fixture. This pressure may have a lateral component, meaning that the waterproof membrane 100 will be subjected to lateral shear forces. If the waterproof membrane 100 bears these shear forces alone, it may develop wrinkles, thereby compromising its waterproof performance. Because the support member 200 is highly resistant to deformation, it hardly deforms when subjected to these shear forces. The shear resistance of the waterproof membrane 100 supported by the support member 200 is therefore also enhanced, so that the degree of wrinkling of the waterproof membrane 100 during assembly will be reduced. The degree of wrinkling of the waterproof membrane 100 may be, based on the fact that the waterproof membrane 100 is in a flat state, the height difference between the highest point and the lowest point of the wrinkled waterproof membrane 100. The greater the height difference, the greater the degree of wrinkling, and the smaller the height difference, the smaller the degree of wrinkling. The degree of wrinkling of the waterproof membrane 100 may be observed by an industrial microscope. The greater the deformation (wrinkling) of the waterproof membrane 100, the more significant the impact of its transfer function on sound propagation, consequently, the greater the changes in the sound quality and volume passing through the waterproof membrane 100. The support member 200 makes the waterproof membrane 100 less susceptible to wrinkling and deformation during assembly, thereby ensuring that the change in the sound transmission loss of the waterproof membrane 100 is relatively small. Moreover, since the waterproof membrane 100 is not easily deformed during assembly, the original shape and initial transfer function of the waterproof membrane 100 can be maintained as much as possible, ensuring the consistency of a plurality of waterproof assemblies 10 on the same earphone or a plurality of waterproof assemblies 10 (the waterproof membrane 100) on different earphones.

The waterproof membrane 100 includes a first waterproof surface 110 and a second waterproof surface 120. In some embodiments, the support member 200 may be a single support member 200, and the single support member 200 may be connected to only one side of the waterproof membrane 100, such as to the first waterproof surface 110 or to the second waterproof surface 120. In other embodiments, the support member 200 may also be implemented as a plurality of support members 200, and the plurality of support members 200 are connected to the waterproof membrane 100 to collectively ensure that the waterproof membrane 100 is less prone to wrinkling in both directions of force (e.g., a direction pointing to the first waterproof surface 110 side and a direction pointing to the second waterproof surface 120 side), further enhancing the shear resistance of the waterproof membrane 100.

In some embodiments, the support member 200 includes a first support member 210 and a second support member 220, and the first support member 210 and the second support member 220 are symmetrically disposed on both sides of the waterproof membrane 100. The first support member 210 is connected to the first waterproof surface 110, and the second support member 220 is connected to the second waterproof surface 120. The waterproof membrane 100 is connected to the support members 200 on both sides of the waterproof membrane 100, so that the waterproof membrane 100 is sandwiched in the middle of two support members 200 to form a sandwich structure. When the waterproof assembly 10 is subjected to a shear force among the forces, the symmetrical structure described above may sandwich the waterproof membrane 100 and move with the waterproof membrane 100, so that the waterproof membrane 100 will not be subjected to the shear force individually and thus be wrinkled and deformed.

The support member 200 and the waterproof membrane 100 may be connected by an adhesive layer 400. In some embodiments, the adhesive layer 400 is an acrylic adhesive. The strength and stiffness of the acrylic adhesive are relatively large, and the use of the acrylic adhesive to bond the support member 200 and the waterproof membrane 100 ensures that the adhesive layer 400 is less likely to deform and cause the waterproof membrane 100 to deform when the support member 200 and the waterproof membrane 100 are subjected to lateral forces. To ensure the bonding strength, a thickness of the adhesive layer 400 should not be too thin or too thick, so as to facilitate the processing of the waterproof assembly 10 while providing sufficient strength to the sandwich structure where the waterproof membrane 100 is sandwiched between the two support members 200. In some embodiments, the thickness of the adhesive layer is in a range of 0.03 mm to 0.15 mm.

The support member 200 is provided with a first through hole 230. When the acoustic device 01 includes the housing and the housing is provided with the sound transmission hole, the first through hole 230 may be adapted to a size of the sound transmission hole. The shape of the first through hole 230 may be circular, rectangular, oval, square, or the like. As shown in FIG. 1B, the first through hole 230 is circular. As long as the shape of the first through hole 230 can be adapted to the sound transmission hole, the present disclosure does not make a specific requirement for the shape of the first through hole 230 herein. The size of the first through hole 230 should also be suitable. Take an example that the support member 200 is annular, and the first through hole 230 is a circular hole for illustration. The range of diameter of the circular hole should not be too small so as not to affect the sound intake, resulting in an increase in the loss of sound from the waterproof assembly 10, and making the waterproof assembly 10 affect the acoustic performance of the acoustic device 01. In some embodiments, the (inner) diameter of the circular hole may be in a range of 0.8 mm-1.8 mm. The annular region of the support member 200 and the waterproof membrane 100 are adhered by the adhesive layer 400. The annular bonding region of the support member 200 and the waterproof membrane 100 should not be too small to ensure the firmness and the waterproofness of the bonding of the support member 200 and the waterproof membrane 100. In some embodiments, the width of the annular bonding region is greater than 0.8 mm to ensure that the annular bonding region has a strong bonding capability. The annular bonding region between the support member 200 and the waterproof membrane 100 should also not be too large to match the assembly space that the acoustic device 01 reserves for the waterproof assembly 10. In some embodiments, the width of the annular bonding region is in a range of 0.8 mm-1.4 mm to ensure that the annular bonding region has a strong bonding capacity and matches the assembly space. In some embodiments, based on the above range of diameter of the circular hole and the range of width of the annular bonding region, the outer diameter of the annular may be in a range of 2.4mm-4.6mm.

In some embodiments, the material of the support member 200 may be Polyethylene Terephthalate (PET). PET has good resistance to deformation, and can support the waterproof membrane 100 and enhance the shear resistance of the waterproof assembly 10 (the waterproof membrane 100). In some embodiments, the thickness of the support member 200 is less than or equal to 0.1 mm, ensuring the support strength and at the same time reducing the space occupied within the housing.

In some embodiments, the buffer member 300 may be an elastic member having an adhesive surface. The adhesive surface is adhesive so as to adhere the waterproof assembly 10 to a target surface after being subjected to an external pressure. In other embodiments, the buffer member 300 may be an elastic adhesive. The acoustic device 01 may include the housing, the housing is provided with the sound transmission hole, and the target surface is a surface of the inner wall of the housing around the sound transmission hole. The buffer member 300 may be adhered to the housing by the adhesive surface, thereby enabling the waterproof assembly 10 to be secured to the inner wall of the housing and to cover the sound transmission hole. For example, the acoustic device 01 may also include an acoustic assembly. A face of the acoustic assembly is the target surface, and the buffer member 300 is adhered to the acoustic assembly by the adhesive surface, thereby securing the acoustic assembly. The buffer member 300 is provided with a second through hole 330, and the second through hole 330 may be similar in shape and size to the first through hole 230 referred to above, and will not be repeated herein.

The buffer member 300 may be connected to the support member 200. In some embodiments, the buffer member 300 may be a single buffer member 300. The single buffer member 300 is connected to one side of the support member 200. In other embodiments, the buffer member 300 may also be a plurality of buffer members 300. For example, the buffer member 300 may include a first buffer member 310 and a second buffer member 320, corresponding to the aforementioned first support member 210 and second support member 220, and the first buffer member 310 is connected to the first support member 210, and the second buffer member 320 is connected to the second support member 220. The first buffer member 310 may include a first connection surface 311 and a first adhesive surface 312. The first connection surface 311 may be connected to the first support member 210. The first connection surface 311 may also be adhesive, and the first connection surface 311 may be adhered to the first support member 210. The second buffer member 320 may include a second connection surface 321 and a second adhesive surface 322. The second connection surface 321 may be connected to the second support member 220. The second connection surface 321 may also be adhesive, and the second connection surface 321 may be adhered to the second support member 220. The first adhesive surface 312 or the second adhesive surface 322 of the buffer member 300 may be adhered to the target surface, and the other adhesive surface may be connected to other parts or other acoustic assemblies in the acoustic device 01.

As previously described, the waterproof assembly 10 may include the single support member 200 and the single buffer member 300. One side of the waterproof membrane 100 may be connected to the support member 200. One side of the support member 200 may be connected to the first waterproof surface 110 of the waterproof membrane 100, and the other side of the support member 200 is connected to the first connection surface 311 of the buffer member 300. The support member 200 and the buffer member 300 form a unilateral structure to support the waterproof membrane 100, thereby providing the waterproof membrane 100 with a stable waterproof effect.

As mentioned earlier, the two sides of the waterproof membrane 100 may be connected to the support member 200, respectively. The two support members 200 sandwich the waterproof membrane 100 to form a “support member 220—waterproof membrane 100—support member 210” sandwich structure. When the waterproof membrane 100 is subjected to a shear force (lateral force) during assembly, the symmetrical structure described above allows the waterproof membrane 100 to be sandwiched by the support member 200 to form an integrated unit. The integrated unit slides from side to side under the action of shear force. That is, the waterproof membrane 100 is not subjected to a separate shear force and thus wrinkled or deformed. Furthermore, two buffer members 300, i.e., the first buffer member 310 and the second buffer member 320, may be attached to both sides of the sandwich structure, respectively. The buffer member 300 may spread out evenly the physical pressure (impact energy) to which the waterproof assembly 10 is subjected, and in turn, the buffer member 300 may protect the waterproof membrane 100 from wrinkling due to excessive impact during the assembly of the waterproof assembly 10, avoiding affecting the waterproof and acoustic performance of the waterproof membrane 100. The side of the buffer member 300 that is not connected to the sandwich structure may be adhesive, to enable the sandwich structure to be adhered to the target surface to complete the assembly. The use of the sandwich structure and the structure of the double-layered support members 210 allows both sides of the waterproof membrane 100 to be protected, and the waterproof performance is more stable.

In some embodiments, when the waterproof assembly 10 is assembled into the interior of the housing of the acoustic device 01, the first adhesive surface 312 may be adhered to the inner wall of the housing around the sound transmission hole. The waterproof assembly 10 is subjected to pressure such that the first adhesive surface 312 and the housing are firmly adhered. For example, the first adhesive surface 312 and the inner wall of the housing may be firmly adhered by applying pressure by means of the pressure fixture in a direction perpendicular to the first adhesive surface 312 for a certain time. Due to the presence of tooling errors, the pressure fixture exerts a force (shear force) on the waterproof assembly 10 along the horizontal direction (direction parallel to the first adhesive surface) in addition to a force along the vertical direction. For example, the waterproof assembly 10 is subjected to pressure generated by the gravity of the acoustic assembly itself. Due to the uncertainty of the placement of the acoustic assembly, there is a force (shear force) of the acoustic assembly on the waterproof assembly 10 along the horizontal direction (direction parallel to the first adhesive surface) in addition to a force along the vertical direction. Due to the strong deformation resistance of the support member 200, the support member 200 hardly deforms when subjected to the shear force described above, thus being able to enhance the shear resistance of the waterproof assembly 10 (the waterproof membrane 100), and ensuring that the waterproof membrane 100 is not easy to deform during assembly, and that the acoustic loss is smaller.

Meanwhile, the aforementioned buffer member 300 is the elastic member or an adhesive having elasticity. In other words, the buffer member 300 has elasticity. The buffer member 300 can spread out evenly the physical pressure (impact energy) of high velocity to which the waterproof assembly 10 is subjected. When the waterproof assembly 10 is subjected to a force in a direction perpendicular to the first adhesive surface 312, the buffer member 300 may be compressed in a vertical direction. Meanwhile, since the buffer member 300 is elastic, even if the waterproof assembly 10 is subjected to a lateral shear force, at least a portion of the shear force may be initially absorbed and released within the elastic buffer member 300. That is, the shear force is used to cause the buffer member 300 to deform laterally. As a result, the effect of the shear force acting on the support member 200 and the waterproof membrane 100 is reduced, preventing the generation of significant shear force on the support member 200 and the waterproof membrane 100. This avoids damage to the internal structures of the support member 200 and the waterproof membrane 100, further enhances the shear resistance of the waterproof assembly 10, and ensures the waterproof performance of the waterproof assembly 10.

Since the buffer member 300 has elasticity, it may produce a larger elastic deformation compared to other structures in the waterproof assembly 10, so that the waterproof assembly 10 may be better adapted to the error of the assembly space in the housing. For example, when the height of the reserved assembly space in the housing of the earphone is small, the waterproof assembly 10 may be adapted to the height of the assembly space by compressing the buffer member 300.

The degree of elastic deformation occurring in the individual components of the waterproof assembly 10 may be determined using the following formula:

(original thickness—compressed thickness)/original thickness×100%.

For example, first record the original thickness of each part, and when the waterproof assembly 10 is pressed down, record the compressed thickness of each component, and then obtain the degree of deformation of each component.

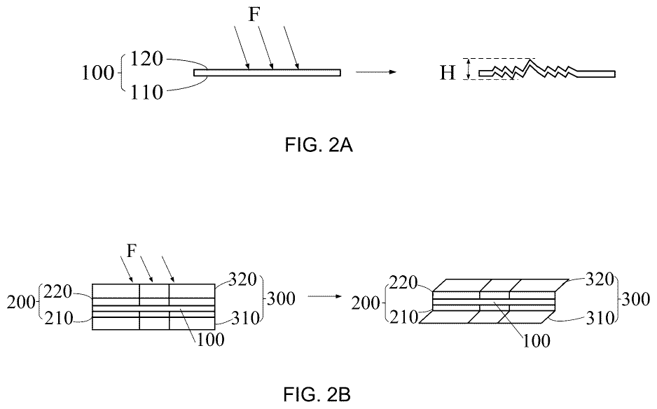

FIG. 2A illustrates a schematic diagram of a waterproof membrane subjected to a pressure according to some embodiments of the present disclosure. FIG. 2B illustrates a schematic diagram of a waterproof assembly subjected to a pressure according to some embodiments of the present disclosure.

The first waterproof surface 110 or the second waterproof surface 120 of the waterproof membrane 100 wrinkles when subjected to a pressure F that is not perpendicular to the surface of the waterproof membrane 100. As shown in FIG. 2A, the pressure F includes a component perpendicular to the surface of the waterproof membrane 100 and a rightward component along the surface of the waterproof membrane 100. The rightward component causes the waterproof membrane 100 to be wrinkled. A height difference H exists between the highest point and the lowest point of the wrinkled waterproof membrane 100.

As shown in FIG. 2B, the support member 200 includes a first support member 210 and a second support member 220, and the first support member 210 and the second support member 220 are symmetrically disposed on both sides of the waterproof membrane 100. Both sides of the waterproof membrane 100 are connected to the support members 200, so that the waterproof membrane 100 is sandwiched between the two support members 200 to form a sandwich structure. When the sandwich structure formed by the waterproof membrane 100 and the support members 200 is also subjected to a pressure F that is not perpendicular to the surface of the waterproof membrane 100. Due to the strong deformation resistance of the support member 200, the support member 200 hardly deforms when subjected to the pressure F as described above. The waterproof membrane 100 is sandwiched therein by the first support member 210 and the second support member 220 to form an integrated unit, and thus also hardly deforms. The first buffer member 310 and the second buffer member 320 are disposed on either side of the support member 200, sandwiching the sandwich structure described above. Because the buffer member 300 is elastic, the buffer member 300 takes up the majority of the deformation when subjected to the pressure F. As shown in FIG. 2B, the component F2 causes the buffer member 300 to deform, thereby driving the waterproof assembly 10 to slide left and right as a whole. In this process, the waterproof membrane 100 undergoes minimal deformation, thereby ensuring that the acoustic loss is minimal.

In some embodiments, the material of the buffer member 300 may be foam adhesive, foam-acrylic adhesive (acrylic ester adhesive), or acrylic adhesive (acrylic ester adhesive). The foam adhesive has the advantages of good elasticity, light weight, and ultra-thin volume, thus can provide good elastic deformation capability, and at the same time reduce the overall volume and weight of the waterproof assembly 10. The acrylic adhesive has the advantages of high strength, impact resistance, and shear strength, thus enhancing the overall strength and shear resistance of the waterproof assembly 10. In some embodiments, the first buffer member 310 and the second buffer member 320 may both be the foam adhesive or may also both be the foam-acrylic adhesive. In other embodiments, one of the first buffer member 310 and the second buffer member 320 is the foam adhesive, and another one of the first buffer member 310 and the second buffer member 320 is the foam-acrylic adhesive.

In some embodiments, a thickness of the buffer member is greater than or equal to 0.1 mm. When the buffer member 100 has a certain thickness, a deformable capacity of the waterproof assembly 10 can be increased so that the waterproof assembly 10 can be easily assembled into the housing. The thicknesses of the first buffer member 310 and the second buffer member 320 may be the same or different. For example, the first buffer member 310 and the second buffer member 320 are both the foam adhesive. The thickness of the foam adhesive used for the first buffer member 310 is 0.1 mm, and the foam adhesive is adhered to the inner wall of the housing. The thickness of the foam adhesive used for the second buffer member 320 is 0.2 mm, and the foam adhesive is adhered to the acoustic assembly. The greater the thickness of the foam adhesive, the greater the waterproof capability and adhesive force. Because the impact of the water pressure on the sound transmission hole is larger, the thickness of the foam adhesive adhered to the inner wall around the sound transmission hole may be a little thicker, so as to ensure that the adhesion is strong.

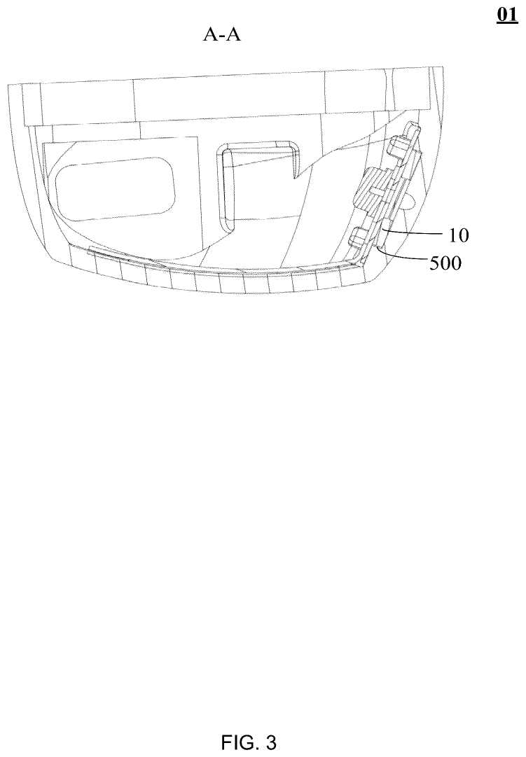

A range of the total thickness of the waterproof assembly 10 may be adapted to be higher than the thickness of the assembly space reserved for the waterproof assembly 10 in the housing of the acoustic device 01 at the sound transmission hole, so that the waterproof assembly 10, after being assembled into the assembly space, may be compressed by the microphone or the speaker within the acoustic device. FIG. 3 illustrates a schematic diagram of a structure of a waterproof assembly 10 installed in an acoustic device 01 according to some embodiments of the present disclosure. In some embodiments, the total thickness of the waterproof assembly is in a range of 0.37 mm-0.61 mm to ensure that the waterproof assembly 10 exists at a certain thickness for ease of installation while decreasing the volume of space occupied by the housing. As in FIG. 3, an accommodation cavity 500 for installing the waterproof assembly 10 is reserved at the sound transmission hole of the earphone. For example, a depth of the accommodation cavity 500 is in a range of 0.25mm-0.45mm, which means that the thickness of the housing reserved for the waterproof assembly 10 is in a range of 0.25 mm-0.45 mm. When the thickness of the waterproof assembly 10 is greater than the depth of the accommodation cavity 500, the waterproof assembly 10, after being placed in the accommodation cavity 500, may be pressed until it is level with the accommodation cavity 500, as shown in FIG. 3.

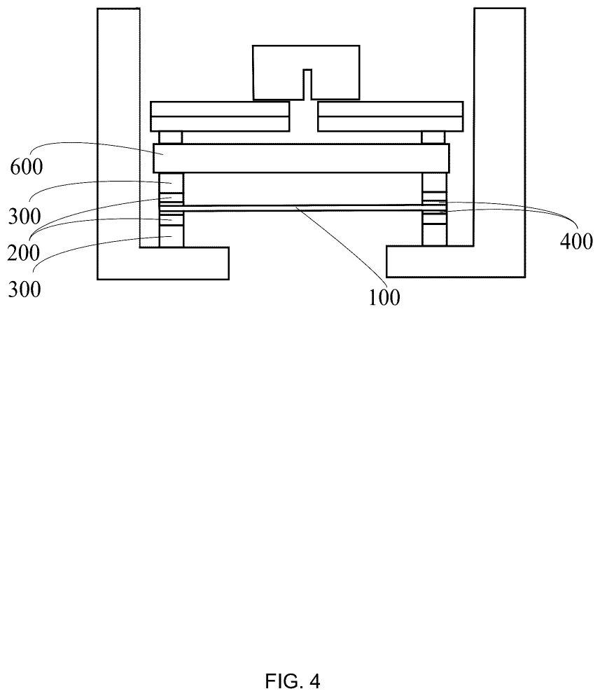

In some embodiments, the waterproof assembly 10 may also include a gauze mesh 600. FIG. 4 illustrates a schematic diagram of a location of a gauze mesh according to some embodiments of the present disclosure. As described above, the acoustic device 01 may include the housing, and the sound transmission hole may be provided on the housing. In some embodiments, the gauze mesh 600 is provided on a side of the waterproof assembly 10 close to the sound transmission hole. When the user wears the acoustic device 01 for underwater activities, if there is a water flow into the acoustic device 01 through the sound transmission hole, the water flow will first flow through the gauze mesh 600, at this time the gauze mesh may disperse the water flow via the mesh, making the impact on the waterproof membrane 100 more dispersed, so that a force on all parts of the waterproof membrane 100 is smaller, and the waterproof membrane 100 is not easy to deform, thereby increasing the waterproof capability of the waterproof membrane 100 (the waterproof assembly 10). In some embodiments, the gauze mesh 600 is provided on a side of the waterproof assembly 10 away from the sound transmission hole, as shown in FIG. 4. When the waterproof membrane 100 encounters a large water pressure, the waterproof membrane 100 may deform, affecting the waterproof performance of the waterproof membrane 100. At this time, the gauze mesh 600 may be set behind the waterproof membrane 100 to play the role of supporting or blocking, to avoid excessive deformation of the waterproof membrane 100, avoiding changes in the acoustic performance of the waterproof membrane 100, and increasing the waterproof capability of the waterproof membrane 100.

In some embodiments, the waterproof assembly 10 may also include a steel mesh. Similar to the gauze mesh, the steel mesh is provided on the side of the waterproof assembly 10 close to the sound transmission hole. The steel mesh may disperse the water flow, to make the impact force on the waterproof membrane 100 more dispersed, so that the force on all parts of the waterproof membrane 100 is smaller, and the waterproof membrane 100 is not easy to deform, to increase the waterproof capability of the waterproof membrane 100 (the waterproof assembly 10). In some embodiments, the steel mesh may be provided on the side of the waterproof assembly 10 away from the sound transmission hole, to act as a support or block behind the waterproof membrane 100, thereby avoiding excessive deformation of the waterproof membrane 100. The steel mesh has greater rigidity, is less prone to deformation, and can withstand a greater amount of water pressure, thereby preventing the waterproof membrane 100 from deforming.

In some embodiments, the waterproof assembly 10 may also include a microporous plate. The microporous plate may be disposed on a side of the waterproof assembly 10 away from the sound transmission hole. In some embodiments, the microporous plate may also be disposed on a side of the waterproof assembly 10 close to the sound transmission hole. The microporous plate serves a purpose similar to that of the gauze mesh and steel mesh described above, and is not described herein.

It is worth stating that the waterproof assembly 10 may be provided with only one of the gauze mesh 600, the steel mesh, or the microporous plate to serve as a diversion or support for the waterproof membrane 100, or the waterproof assembly 10 may be provided with more than one of the gauze mesh 600, the steel mesh, and the microporous plate, thereby enhancing the ability to protect the waterproof assembly 10. In some embodiments, the waterproof assembly 10 includes both the gauze mesh 600 and the steel mesh.

In summary, the present disclosure provides the waterproof assembly 10 of the sound transmission hole of the acoustic device 01. The waterproof assembly 10 is provided with the sandwich structure of “support member 200—waterproof membrane 100—support member 200” to realize that the waterproof membrane 100 of the waterproof assembly 10 is not easily damaged by shear force during assembly into the acoustic device 01, so that the waterproof assembly 10 can maintain good acoustic performance and waterproof effect. Furthermore, the support members 200 in the present disclosure are symmetrically stacked on both sides of the aforementioned sandwich structure, forming a more stable and symmetrically distributed stacking structure, ensuring that the waterproof membrane 100 is supported and protected at the top and bottom, so that the waterproof membrane 100 can maintain good acoustic performance and waterproof effect, further enhancing the waterproof effect of the waterproof assembly 10.

The above describes a particular embodiment of the present disclosure. Other embodiments are within the scope of the appended claims. In some embodiments, the operations or steps documented in the claims may be performed in a different order than in the embodiments and still achieve the desired results. Additionally, the processes depicted in the figures do not necessarily need to be shown in a particular order or consecutive order to achieve the desired results. In some implementations, multitasking and parallel processing are also possible or may be advantageous.

In summary, after reading the present detailed disclosure, a person skilled in the art may appreciate that the foregoing detailed disclosure is presented by way of example only and may not be limiting. While not expressly stated herein, a person skilled in the art may understand that the present disclosure needs to encompass a plurality of reasonable alterations, improvements, and modifications to the embodiments. These alterations, improvements, and modifications are intended to be presented by the present disclosure and are within the spirit and scope of the exemplary embodiments of the present disclosure.

In addition, certain terminology in the present disclosure has been used to describe exemplary embodiments of the present disclosure. For example, “an embodiment,” “embodiments,” and/or “some embodiments” means that a particular feature, structure, or characteristic described in conjunction with the embodiment may be included in at least one embodiment of the present disclosure. Accordingly, it may be emphasized and should be understood that the terms “an embodiment” or “alternative embodiment” in various parts of the present disclosure do not necessarily all refer to the same embodiment. In addition, particular features, structures, or characteristics may be suitably combined in one or more embodiments of the present disclosure.

It should be understood that in the foregoing descriptions of embodiments of the present disclosure, various features have been combined in a single embodiment, a figure, or the description thereof, in order to aid in the comprehension of a feature, and for the purpose of simplifying the present disclosure. However, this is not to say that the combination of these features is necessary, and it is entirely possible that a person skilled in the art could extract some of these features as separate embodiments to be understood when reading the present disclosure. That is to say, the embodiments in the present disclosure may also be understood as a consolidation of a plurality of sub-embodiments. And this also holds true when the content of each of the sub-embodiments lies in fewer than all of the features of a single previously disclosed embodiment.

Each patent, patent application, publication of a patent application, and other material cited herein, such as articles, books, specifications, publications, documents, articles, etc., may be incorporated herein by reference, now or hereafter associated with this document, except for any prosecution document history relating thereto that may be inconsistent or in conflict herewith, or that may limit the broadest scope of the claims or any identical thereof. For example, in the event of any inconsistency or conflict between the descriptions, definitions, and/or use of terms associated with any of the included materials in connection with this document and the descriptions, definitions, and/or use of terms in the present disclosure, the use of the terms in the present disclosure shall prevail.

Finally, it should be understood that the embodiments of the present disclosure disclosed herein are illustrations of the principles of the embodiments of the present disclosure. Other modified embodiments are within the scope of the present disclosure. The embodiments disclosed in the present disclosure are therefore intended to be exemplary only and not limiting. A person skilled in the art may adopt alternative configurations based on the embodiments in the present disclosure to realize the application in the present disclosure. Thus, embodiments in the present disclosure are not limited to those embodiments that are precisely described in the present disclosure.

1. A waterproof assembly for a sound transmission hole of an acoustic device, comprising:
a waterproof membrane, configured to allow air molecules to pass through and block water molecules from passing through;
a buffer member, including an adhesive surface, wherein the adhesive surface is adhesive so as to adhere the waterproof assembly to a target surface after being subjected to an external pressure; and
a support member, located between the waterproof membrane and the buffer member, configured to reduce a degree of wrinkling of the waterproof membrane when the waterproof assembly is assembled to the acoustic device,
wherein the support member and the buffer member are respectively provided with a first through hole and a second through hole.

2. The waterproof assembly according to claim 1, wherein the acoustic device includes an acoustic sensor, and the acoustic sensor is a speaker or a microphone; and
when the acoustic device is operating, at least part of sound waves are transmitted into or from the acoustic device through the waterproof membrane.

3. The waterproof assembly according to claim 1, wherein
the waterproof membrane includes a first waterproof surface and a second waterproof surface;
the support member includes a first support member and a second support member, wherein the first support member is connected to the first waterproof surface, and the second support member is connected to the second waterproof surface;
the buffer member includes a first buffer member and a second buffer member, the first buffer member includes a first connection surface and a first adhesive surface, the first connection surface is connected to the first support member, the second buffer member includes a second connection surface and a second adhesive surface, and the second connection surface is connected to the second support member.

4. The waterproof assembly according to claim 1, wherein
the waterproof membrane includes a first waterproof surface and a second waterproof surface;
the buffer member includes a first connection surface and a first adhesive surface;
one side of the support member is connected to the first waterproof surface, and another side of the support member is connected to the first connection surface.

5. The waterproof assembly according to claim 1, wherein
the support member and the waterproof membrane are connected by an adhesive layer; and
a thickness of the adhesive layer is in a range of 0.03 mm to 0.15 mm.

6. The waterproof assembly according to claim 1, further comprising a gauze mesh, connected to the buffer member, so as to enhance a waterproof capability of the waterproof assembly.

7. The waterproof assembly according to claim 6, wherein the acoustic device comprises a housing, the sound transmission hole is provided on the housing, and the gauze mesh is provided on a side of the waterproof assembly close to the sound transmission hole.

8. The waterproof assembly according to claim 1, wherein the buffer member and the support member are annular, the first through hole and the second through hole are circular holes, and diameters of the first through hole and the second through hole are in a range of 0.8 mm to 1.8 mm; and
outer diameters of the buffer member and the support member are in a range of 2.4 mm to 4.6 mm.

9. The waterproof assembly according to claim 1, wherein a thickness of the waterproof membrane is less than or equal to 0.10 mm.

10. The waterproof assembly according to claim 1, wherein the buffer member is an elastic member, and when the waterproof assembly is assembled, the buffer member is a component with a largest elastic deformation in the waterproof assembly.

11. The waterproof assembly according to claim 1, wherein a material of the buffer member includes foam adhesive or acrylic adhesive.

12. The waterproof assembly according to claim 10, wherein
a thickness of the buffer member is greater than or equal to 0.1 mm.

13. The waterproof assembly according to claim 1 wherein a thickness of the support member is less than or equal to 0.1 mm.

14. The waterproof assembly according to claim 1, wherein a total thickness of the waterproof assembly is in a range of 0.37 mm to 0.61 mm, so as to be installed in the acoustic device.
